(19) United States
(12) Patent Application Publication
(10) Pub. No.: US 2008/0056295 A1
(43) Pub. Date: Mar. 6, 2008

(54) Internet protocol quality of service apparatus and method

(75) Inventors: Joseph C. Loda, Cheshire, CT (US); John P. Conover, Windsor, CT (US)

Correspondence Address: BACHMAN & LAPOINTE, P.C., 900 CHAPEL STREET, SUITE 1201, NEW HAVEN, CT, 06510, US

(73) Assignee: DNE Technologies, Inc.

(21) Appl. No.: 11/897,627

(22) Filed: Aug. 31, 2007

Related U.S. Application Data
(60) Provisional application No. 60/841,862, filed on Sep. 1, 2006.

(51) Int. Cl. H04J 3/16

(52) U.S. Cl. 370/437

(57) ABSTRACT

An internet protocol (IP) quality of service (QoS) apparatus in which individual downlink IP data streams of varying priority and bandwidth are converted to uniformly sized cells, prioritized, and aggregated at a data rate corresponding to a limited bandwidth uplink. The cells are returned to their native format for transmission over the limited bandwidth uplink in an uplink direction and similarly process in a downlink direction.

### CROSS REFERENCE TO RELATED APPLICATIONS

This application claims the benefit of U.S. Provisional Application No. 60/841,862, filed on Sep. 1, 2006, the disclosure which is incorporated herein by reference in its entirety.

### BACKGROUND OF THE INVENTION

The invention relates generally to the field of Internet Protocol (IP) networking. More specifically, embodiments of the invention relate to apparatus and methods ensuring IP quality of service (QoS) when networking with constrained bandwidth environments.

When enterprises began using telephone company services such as Integrated Services Digital Network (ISDN) and leased lines for connecting their geographically remote offices into a wide area network (WAN), QoS referred to the reliability of the carrier's WAN services for carrying network traffic, which was especially important for synchronous links between mainframes and remote terminals. However, QoS in its modern sense is associated with the emergence of Asynchronous Transfer Mode (ATM) networking, a technology that allows QoS parameters such as delay, jitter and loss to be enforced for traffic traveling over the network. Today, Ethernet is becoming the WAN transport of choice due to its inexpensive nature and large availability. Initially, QoS for Ethernet was not required due to the higher aggregate bandwidth and the fact that nearly all of the traffic was data based rather than real time voice and/or video.

Network performance characteristics such as bandwidth, latency, packet loss and jitter (variation in delay) can have negative effects on some applications. For example, voice communications and streaming video can be frustrating when delivered over a network with insufficient or limited bandwidth, unpredictable latency, undesired packet loss or jitter. QoS makes sure that a network's bandwidth, latency, packet loss and jitter are predictable and suited to the needs of applications that use that network.

ATM allows traffic contracts to be established nearly end-to-end, for different types of applications running on the network to ensure that applications that are sensitive to delay or that require bandwidth perform as desired. The fact that ATM employs fixed-size 53-byte cells is an advantage in implementing QoS on this technology, because it is inherently easier to process fixed-size cells faster and more efficiently than variable-length ones.

The greatest interest today is bringing reliable and predictable QoS to IP networks such as the Internet. IP was originally designed as a best effort delivery service with no guarantees of reliability, delay or performance. As a result of the underlying operation of the Transmission Control Protocol (TCP) used to establish connection oriented IP sessions, along with User Datagram Protocol (UDP) for best effort connectionless oriented transmission, and because IP employs variable-length packets that are more complex for routers and local area network (LAN) switches to process than fixed size ATM cells, it has been difficult to bring QoS to IP networks and end user devices.

In the realm of IP networks, QoS may be implemented using the same basic approaches used in ATM, namely, prioritization and resource reservation so that a predictable traffic flow result will occur during non-congested and congested states. A non-congested state is where enough bandwidth is available for all of a user's traffic flow needs. A congested state is where total traffic flow bandwidth requirements exceed the available bandwidth.

Prioritization is the way a particular IP packet will be handled by QoS-enabled devices, such as suitable routers and switches, on the network and is embedded within the packet itself. IP QoS prioritization works on a per port and/or a packet-by-packet basis, and as a packet traverses the network the various switches and routers handle the packet independently of one another (stateless. QoS). Priority-based QoS is configured by setting packet-forwarding rules on the routers and switches on the network, so all such devices on the network must support this feature in order for it to work properly.

Priority-based IP QoS schemes generally employ multiple queues on suitable routers and switches so that different types of traffic (packets carrying various types of payloads each having different priorities) are delivered to different queues on the device. The device then processes these queues in a way that ensures that traffic with high priority is processed first. IEEE 802.1p is a standard to provide traffic class expediting and dynamic multicast filtering and is implemented at Layer 2 (the data link layer) of the Open Systems Interconnection (OSI) reference model. IEEE 802.1p provides traffic class expediting and dynamic multicast filtering. Essentially, it provides a mechanism for implementing QoS at the Media Access Control (MAC) level. Another standard used could be a Layer 3 approach to IP QoS prioritization called DiffServ based upon IETF RFC (Request for Comments) 2475 (An Architecture for Differentiated Services). However, the handling of QoS at any layer, or based upon any definition or standard, has not been uniformly accepted or implemented across the industry. Therefore, assuring standardization means specific traffic behavior control is nearly impossible.

While there are some technologies like Resource ReSerVation Protocol (RSVP) in the IP networking arena that attempt to provide connection oriented services similar to those of the more traditional TDM networks, these technologies are not commonplace. In addition to not having been widely adopted, these protocols still suffer from latency caused by large packet sizes. Latency causes high-priority traffic to be held up because it may arrive just after the start of transmission of a large low-priority packet over a bandwidth constrained link.

Constrained bandwidth environments exist in many commercial and military networks due to intermediate satellite and terrestrial links. Satellite and terrestrial links are generally susceptible and dependent on weather conditions that disturb the atmosphere and adversely affect available bandwidth and therefore overall QoS affecting any application. While there may be virtually unconstrained bandwidth on either side of a constrained bandwidth link, these links form a bottleneck. Network engineers would like to guarantee the transmission of high-priority traffic while allowing lower priority traffic to use the bandwidth that is reserved for high priority traffic when the high priority traffic is not present.

### SUMMARY OF THE INVENTION

The inventors have discovered apparatus and methods for providing IP QoS for networks when transmitting data over a bandwidth-limited data link(s) that can be controlled by a user. The invention couples one or more IP traffic downlinks, each having a data rate, with one or more uplinks having a data rate that may be constrained. An embodiment converts the variable-size variable rate IP packets to uniformly sized ATM cells, prioritizes the traffic flow, assigns its bandwidth behavior while using a traffic management rate limiter to invoke a higher order traffic congestion control by limiting the overall data rates of the total downlink traffic data flows to the uplink data flow. The invention allows the user to control the individual traffic flow behavior and the aggregate data flow so that in times of congestion or in times of reduced available bandwidth, high-priority traffic may be given precedence over low-priority traffic. These features apply in downlink to uplink or uplink to downlink directions.

In some embodiments, a protocol is employed that communicates the available bandwidth of a dynamically changing downlink and/or uplink to dynamically adjust the traffic flows, including bandwidth limits. When more than one uplink exists, the downlink traffic may be apportioned between the uplinks based on their available bandwidth.

One aspect of the invention is a method of providing quality of service for IP networks when transmitting IP data streams over a constrained bandwidth data link. Methods according to this aspect of the invention preferably start with receiving a plurality of downlink IP data streams containing packets and at least one uplink IP data stream containing packets, assigning each downlink packet and each uplink packet a priority and a data rate, segmenting each downlink packet and each uplink packet into a number of cells corresponding to their packet, selecting downlink cells based on their assigned packet priority and at their assigned packet data rate, selecting uplink cells based on their packet priority and at their packet data rate, assembling the selected downlink and uplink cells back to their original packets, addressing the downlink packets to a destination uplink, and addressing the uplink packets to a destination downlink.

Another aspect of the method is where the sum of all downlink packet data rates for packets having the same destination uplink is less than or equal to a data rate of the destination uplink (uplink aggregate data rate).

Another aspect of the method is where the downlink packet data rates for packets having the same destination uplink are equal to or greater than a data rate of the destination uplink (uplink aggregate data rate).

Another aspect of the method is where the sum of all uplink packet data rates for packets having the same destination downlink is less than or equal to a data rate of the destination downlink (downlink aggregate data rate).

Another aspect of the method is where the uplink packet data rates for packets having the same destination downlink are equal to or greater than a data rate of the destination downlink (downlink aggregate data rate).

Another aspect of the method is where further comprises detecting a denial of service (DoS) attack on a downlink IP data stream and/or an uplink IP data stream, and blocking the downlink IP data stream and/or uplink IP data stream experiencing the DoS attack.

Another aspect of the invention is an apparatus for providing quality of service for IP networks when transmitting IP data streams over a constrained bandwidth data link. Apparatus according to this aspect of the invention comprise means for receiving a plurality of downlink IP data streams containing packets and at least one uplink IP data stream containing packets, means for assigning each downlink packet and each uplink packet a priority and a data rate, means for segmenting each downlink packet and each uplink packet into a number of cells corresponding to their packet, means for selecting downlink cells based on their packet priority and at their packet data rate, means for selecting uplink cells based on their assigned packet priority and at their assigned packet data rate, means for assembling the selected downlink and uplink cells back to their original packets, means for addressing the downlink packets to a destination uplink, and means for addressing the uplink packets to a destination downlink.

Another aspect of the invention is an apparatus for providing quality of service for IP networks when transmitting IP data streams over a constrained bandwidth data link. Apparatus according to this aspect of the invention comprise a plurality of downlink ports configured to receive and output an IP data stream containing packets, at least one uplink port configured to receive and output an IP data stream containing packets, a segmentation engine coupled to the downlink ports and the at least one uplink port, the segmentation engine configured to segment received downlink and uplink packets into downlink and uplink cells corresponding to their packet, a classifier coupled to the segmentation engine, the classifier configured to prioritize the downlink and uplink cells according to a packet priority, a plurality of traffic queues coupled to the classifier, each traffic queue configured to store downlink and uplink cells according to their packet priority, a plurality of shapers, one coupled to each traffic queue, each shaper configured to extract the downlink and uplink cells from the traffic queues using a form of a weighted round robin algorithm, a forwarding component coupled to the plurality of shapers, the forwarding component configured to select and combine cells from the shapers, a rate limiter coupled to the forwarding component, the rate limiter configured to select cells from the forwarding component based on an assigned packet data rate and an aggregate data rate of a destination uplink or an aggregate data rate of a destination downlink, and a reassembly engine coupled to the rate limiter, the reassembly engine configured to reassemble downlink and uplink cells from the forwarding component back to their original packet for output at a destination uplink or destination downlink port.

Another aspect of the invention is an apparatus for providing quality of service for IP networks when transmitting IP data streams over a constrained bandwidth data link. Apparatus according to this aspect of the invention comprise a housing having a plurality of downlink ports configured to receive and output an IP data stream containing packets, at least one uplink port configured to receive and output an IP data stream containing packets, a segmentation engine coupled to the downlink and uplink ports configured to segment downlink and uplink packets into downlink and uplink cells corresponding to their packet, a classifier coupled to the segmentation engine, the classifier configured to prioritize the downlink and uplink cells according to a packet priority, a plurality of traffic queues coupled to the classifier, each traffic queue corresponding to a downlink and uplink port priority, a plurality of shapers, one coupled to each traffic queue, each shaper configured to extract the downlink and uplink cells from the traffic queues using a form of a weighted round robin algorithm, a forwarding component coupled to the plurality of shapers, the forwarding component configured to select and combine cells from the shapers, a rate limiter coupled to the forwarding component, the rate limiter configured to select cells from a shaper based on an aggregate data rate of a destination uplink and to select cells at an aggregate data rate of a destination downlink, and a reassembly engine coupled to the rate limiter, the reassembly engine configured to reassemble downlink and uplink cells from the intermediate data stream back to their original packet for output at a destination uplink or destination downlink port.

The details of one or more embodiments of the invention are set forth in the accompanying drawings and the description below. Other features, objects, and advantages of the invention will be apparent from the description and drawings, and from the claims.

### BRIEF DESCRIPTION OF THE DRAWINGS

FIG. 1 is a block diagram of an exemplary QoS apparatus.

FIG. 2 is an exemplary IEEE 802.3 packet.

FIG. 3 is an exemplary TCP/IP version 4 (IPv4) header.

FIG. 4 is an exemplary ATM UNI (User-network interface) cell.

FIG. 5 is an exemplary traffic flow method from downlinks to uplinks.

FIG. 6 is an exemplary traffic flow method from uplinks to downlinks.

### DETAILED DESCRIPTION

Embodiments of the invention will be described with reference to the accompanying drawing figures wherein like numbers represent like elements throughout. Further, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. The terms “mounted,” “connected,” and “coupled” are used broadly and encompass both direct and indirect mounting, connecting, and coupling. Further, “connected” and “coupled” are not restricted to physical or mechanical connections or couplings.

The invention is not limited to any particular software language described or implied in the figures. A variety of alternative software languages may be used for implementation of the invention. Some components and items are illustrated and described as if they were hardware elements, as is common practice within the art. However, various components in the method and apparatus may be implemented in software or hardware such as FPGAs, ASICs and processors.

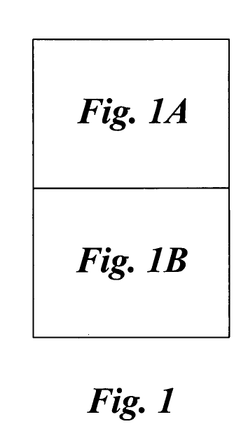

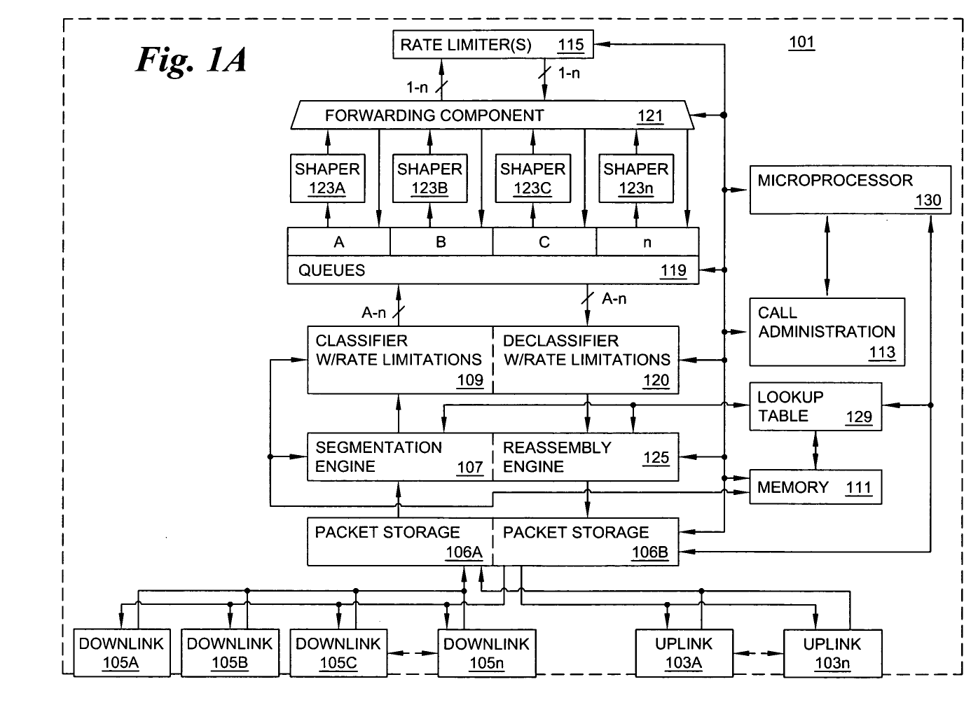

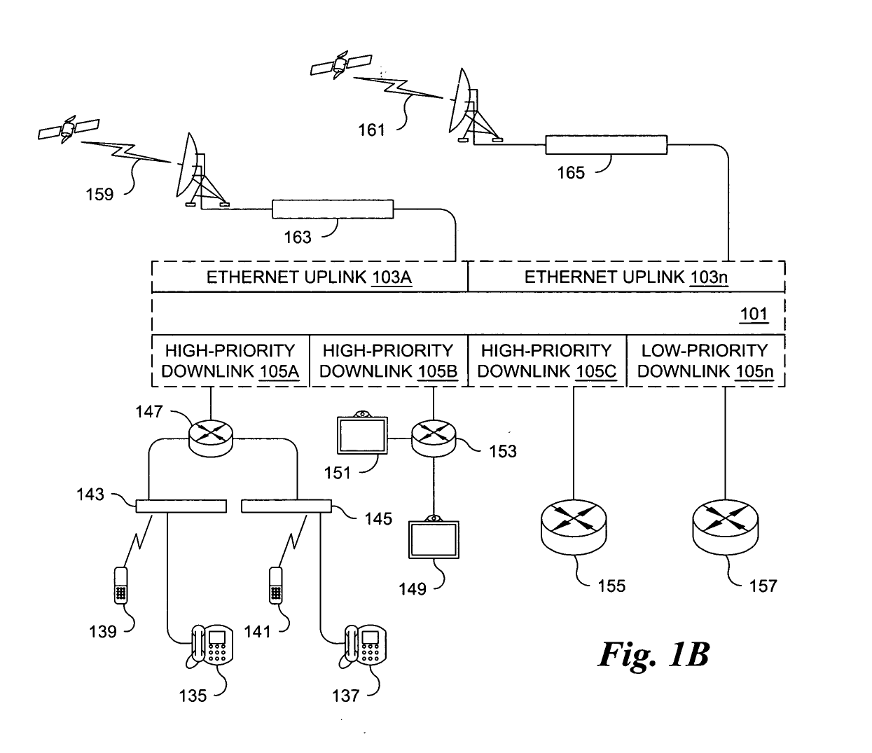

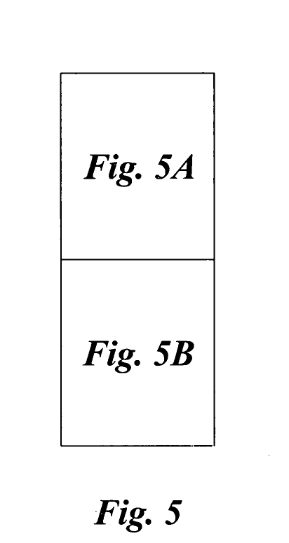

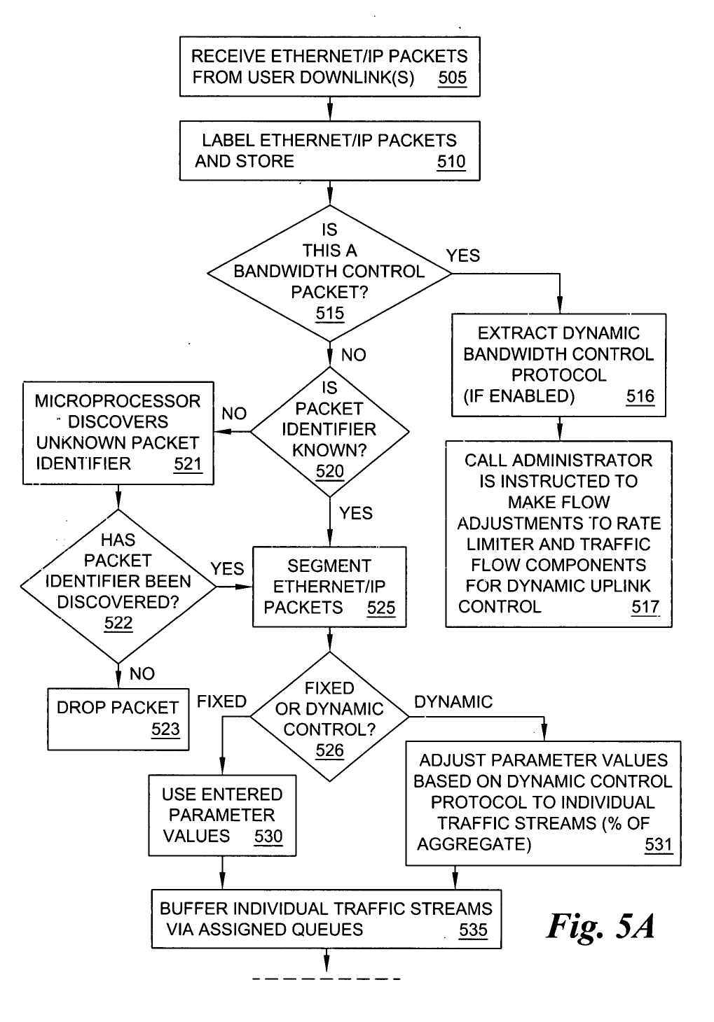

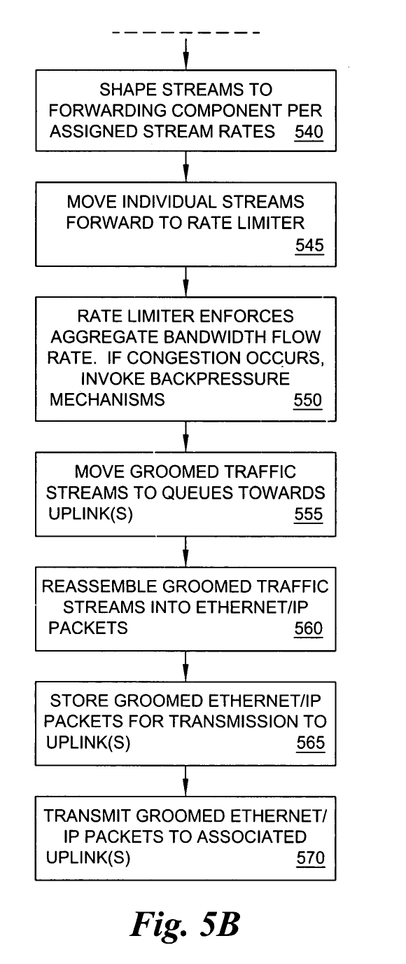

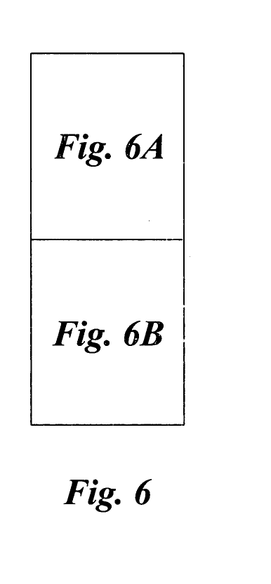

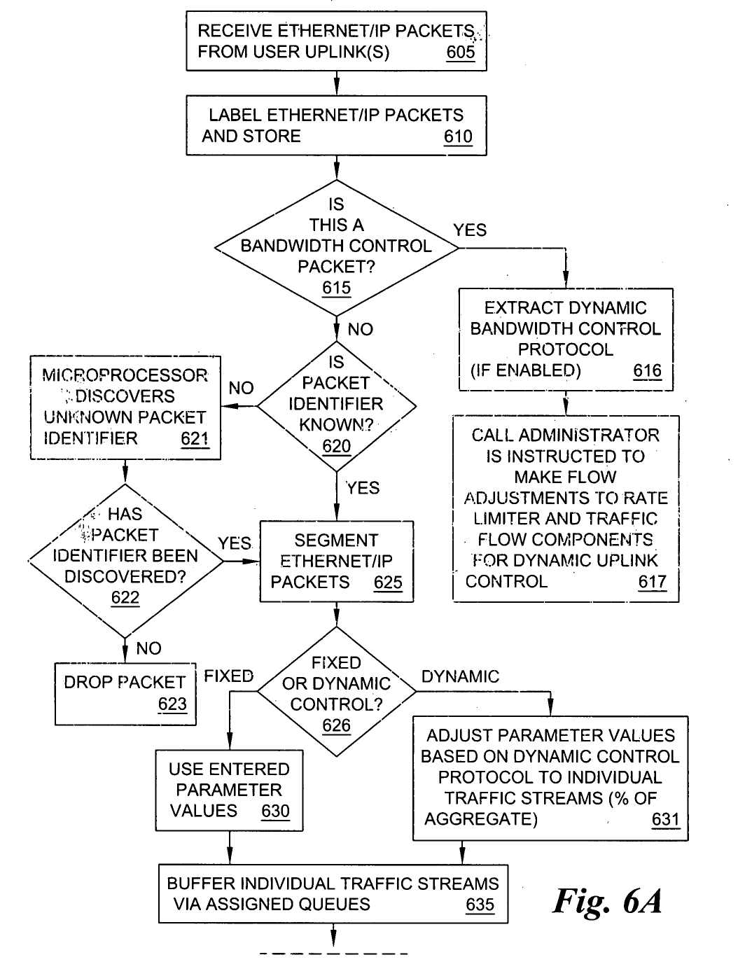

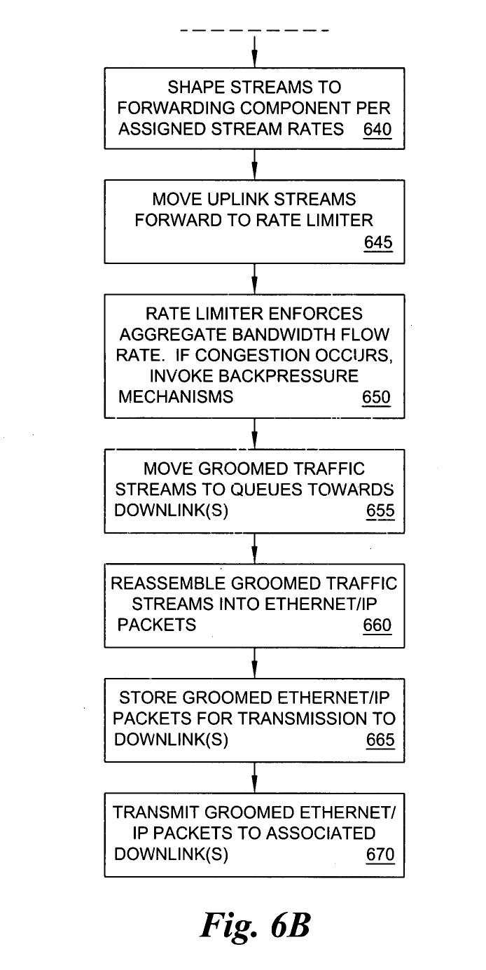

FIG. 1 shows an embodiment of an IP QoS apparatus 101. FIG. 5 shows a traffic flow method from downlinks to uplinks. FIG. 6 shows a traffic flow method from uplinks to downlinks. The apparatus 101 provides at least one uplink port 103A, . . . 103n (uplinks) (collectively 103) and a plurality of downlink ports 105A, 105B, 105C, . . . 105n (downlinks) (collectively 105). The uplinks 103 are aggregated network transmission ports that face the network. The downlinks 105 are user traffic ports that face an application. The uplinks 103 and downlinks 105 receive bidirectional Ethernet traffic. The apparatus processes traffic flowing from a downlink to an uplink (uplink direction) and/or from an uplink to a downlink (downlink direction). The apparatus 101 may be contained in one enclosure and powered by an onboard power supply.

The downlinks 105 and uplinks 103 may support a logical conversion to Ethernet/IP from an original physical interface form such as EIA-530, T1, etc., and pass through the same system as a typical Ethernet/IP packet. The conversion protocol may be a standard or proprietary based method. They may also support various physical interface types, such as EIA-530, T1, etc. to carry the Ethernet/IP traffic.

In one application, the downlinks 105 may couple directly with voice over Internet protocols (VoIP), video teleconference (VTC) services and various IP packets types having different priorities and carried via Ethernet. The VoIP service may use IP phones 135, 137 and Secure Communications Interoperability Protocol (SCIP) devices 139, 141 that can communicate over voice media gateways 143, 145 coupled to a router 147. The VTC devices 149, 151 can communicate over a router 153. IP services such as a secure IP router (SIPR) 155 for Ethernet traffic and regular IP version 4 (IPv4) or IPv6 traffic 157. Other devices (not shown) may be used in line to secure, if required, the traffic flowing between a user device and the apparatus 101.

The uplinks 103 may communicate with a network using IP over satellite 159, 161 or radio/terrestrial links (not shown) while using secure modems 163, 165. Other devices (not shown) may be used in line to secure the traffic flowing between the transmission device and the apparatus 101.

In one example, the downlinks 105 and uplinks 103 communicate with an application and network using data packets as specified under IEEE 802.3 such as 10 Mbps Ethernet (original 802.3 standard), 100 Mbps Fast Ethernet (802.3u), 1 Gigabit Ethernet (GbE) (802.3z and 802.3ab), 10 Gigabit Ethernet (under development), and others.

The downlinks 105 and uplinks 103 may also couple with any optical, wireline, wireless, broadband or other type of data network used in commercial, government or military applications through which voice or data communications may be accomplished.

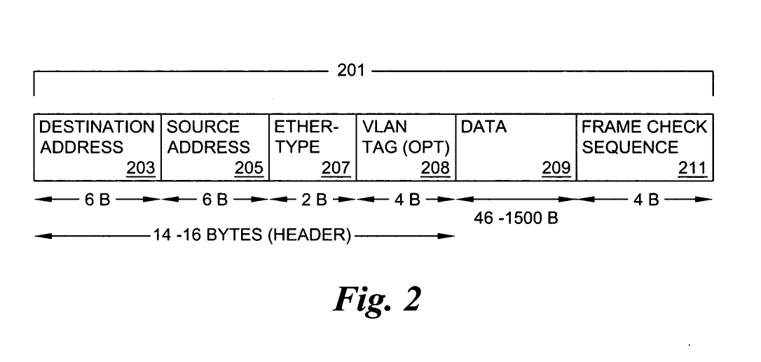

FIG. 2 shows an exemplary Ethernet frame 201. A frame is a segment of data transmitted over a network or telecommunications link using the link-layer protocol appropriate for that network. Frames are assembled and generated by the data-link layer and physical layer of the OSI reference model. An IP datagram is a unit of data that is managed by the IP including the data that is being transmitted as well as the IP headers associated with the data. An IP datagram is the unit of data that IP works with explicitly. The apparatus 101 may use characteristics of an Ethernet frame 201 to perform the claimed functions.

An IP packet is another term for IP datagram. Packets from the network layer are encapsulated by the data-link layer into frames. A sending and receiving system will look at an IP datagram as a single entity, while that datagram may have been split into multiple IP packets for transmission across a set of intermediary networks. Hosts deal with IP datagrams while routers deal with IP packets.

The frame 201 contains a plurality of fields for transporting binary information necessary for networking applications and is used to carry IPv4 or IPv6 encapsulated data. The frame contains two address fields, one for destination 203 and one for source 205. An EtherType field 207 which indicates the protocol used in the data field 209 of the frame, and a frame check sequence (FCS) field 211 for error-checking information. Usually, 0x0600 in hexadecimal is loaded into the EtherType field 207. When VLANs are used, the EtherType field is set to 0x800. An optional VLAN identifier 208 contains a 2-byte VLAN tag and the original 2-byte EtherType field 207 data. The data field 209 contains TCP/IPv4-v6 header information, data and padding, if required.

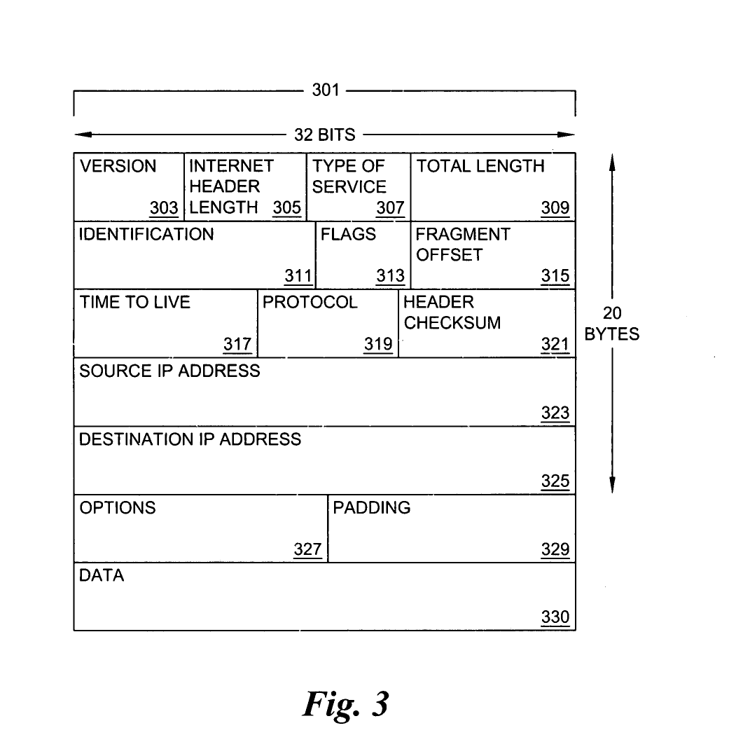

FIG. 3 shows an exemplary IPv4 packet 301. The current version of IP is IPv4 with IPv6 gaining acceptance. IPv4 employs a 32-bit IP addressing scheme that is the network layer protocol used by TCP/IP networks worldwide. An IP packet 301 is typically transported across a network encapsulated in the data field 209 of a frame 201. The apparatus 101 may use characteristics of the TCP/IP protocol (v4, v6) to perform the claimed functions.

The IP packet includes a header, payload and trailer. The IPv4 packet header includes its version 303, header length 305, type of service 307 which allows the host to define what kind of service is desired (speed vs. reliability) indicating the QoS (i.e. RFC 2475 priority) that the packet should have, total length of the packet 309 in bytes, fragmented packet identifier number 311 and to assist reconstructing the packet from several fragments, a flag 313 that indicates if the packet is allowed to be fragmented or not, fragment offset 315 to identify which fragment the packet belongs to, time to live (TTL) 317 value which is the number of hops (router, computer or device along a network) the packet is allowed to pass before it dies (for example, a packet with a TTL of sixteen will be allowed to go across sixteen routers to get to its destination before it is discarded), upper layer protocol identification 319 (TCP, UDP, ICMP, etc.), header checksum 321 used in error correction, the source IP address 323, and destination address 325. After the above, optional flags 327 and padding 329 may be added of varied length which may change based on the protocol used. To complete the packet, the data 330 that the packet carries is added and is followed by additional packet data (not shown). The destination address 203 and source address 205 are read.

With the Ethernet and TCP/IP fields defined, the apparatus 101 can search for the EtherType field 207 which is used to indicate which protocol is being transported in an Ethernet frame 201. The EtherType field 207 for a packet 301 identifies either the next-higher protocol type of the information carried in the data field 209 of the packet 301, or the length of the uncategorized information carried in the data field 209 of packet 301.

The apparatus may use the destination address 203, the source address 205, the EtherType 207, VLAN tag 208, the version field 303, the type of service field 307, the protocol field 319, the source IP address field 323, the destination IP address field 325, or other fields of a packet 301 to provide overall user selectable quality of service functions. The purposes served by these fields are described below.

Initial network planning is required to determine how to configure the apparatus 101. A number of items are required as initial baselines and reference points. The available aggregate rate for an uplink may be known or provided, for example, a 2 Mbps uplink bandwidth, or a message will be dynamically received. Then the number of uplink(s) will be determined. When the number of downlink ports is determined, a total number of services is known that requires access to the uplink(s). The downlink traffic flow bandwidth requirements are compared to the total uplink bandwidth to determine if there is room to fit the desired traffic and to allow the flexibility for traffic flow changes due to behaviors. To understand the function and use of a physical Ethernet port, a downlink 105 is connected to a user supplied device such as an IP Phone, router or a lower-order network. An uplink 103 is connected to the transmission network or a higher-order device for inclusion into another traffic flow. Uplinks may be connected to Ethernet modems, radio links or another device used for transmission of the aggregated flow. These physical Ethernet ports may connect at 10 Mbps, 100 Mbps or 1000 Mbps data link configuration speeds.

The user decides upon a network design that the apparatus 101 is used in based upon the traffic to be carried by a downlink, where and how it is to be carried via an uplink while ensuring the applied traffic behaves in the desired manner while the traffic is in a non-congested or congested state. To interconnect and associate the downlink port(s) to a particular uplink, internal virtual circuits are made in two parts. First, a virtual circuit is made from a downlink port 105 to a rate limiter 115. Next, a virtual circuit is made from the rate limiter 115 to an uplink port 103. This completes the downlink to uplink and uplink to downlink connection paths. There are a number of ways to implement this function. One example is to divide the known aggregate bandwidth into smaller downlink slices and fix the throughput to a specified rate. For example, a 2 Mbps aggregate may use three downlinks ports using 500 kbps, 500 kbps and 1 Mbps, respectively. Therefore, none of the downlinks will exceed these rates. It reveals aggregate inefficiencies, but it is the user's design. Another example is to use the same 2 Mbps aggregate with three downlink ports that are each defined for 2 Mbps of throughput. Therefore, when all three ports are transmitting 2 Mbps each, they are all limited to a total of 2 Mbps. In addition, in the absence of one or two of the three downlink traffic flows, the remaining flow can transmit up to the aggregate rate. The user has the responsibility to determine how the overall traffic is to behave and what prioritization will occur using a particular efficiency.

Once the design is complete, the apparatus 101 is user configured via a user interface (i.e. serial craft port, Web browser, Telnet, etc.). The interface interrogates and downloads the configuration to the apparatus 101 to perform the functions on the applied traffic flows. The configuration combines downlink(s) 105 and uplink(s) 103 traffic flows into downlink to uplink and uplink to downlink directions, in conjunction with validating, classifying and grooming the traffic for the network design.

Internally, the physical Ethernet ports (downlink(s) 105 and uplink(s) 103) are associated with a predefined logical group as configured by the user and stored in a memory 111. To enhance the traffic security embodiment aspect, each logical group is structured so that it is isolated from another group. This ensures that any associated traffic information is not shared among multiple ports unless sharing is part of the configuration.

The configuration defines a virtual circuit (PVC (permanent virtual circuit) or SVC (switched virtual circuit)) to establish a path between the downlink(s) 105 and uplink(s) 103 for the traffic to flow. The virtual circuit includes parameters such as prioritization, traffic handling instructions, bandwidth limits, connection path identifiers, combinations, congestion control, etc. This provides paths for traffic in either a downlink or uplink direction simultaneously. Traffic flows can then be applied to the downlink(s) 105 and uplink(s) 103.

When traffic is applied to the apparatus 101, it behaves in accordance to the design configuration over the link. Networking standards employ broadcast packets (one packet sent to all possible receivers), multicast packets (one packet sent to a plurality of receivers) and unicast packets (one packet sent to a specific receiver), the packets are stored in a packet storage 106A, and a segmentation engine 107 inspects the incoming packets for these particular cases. Packets are input to the apparatus 101 either from the downlink(s) 105 or uplink(s) 103.

If the apparatus 101 detects the arrival of packets at a rate greater than a predetermined value, it will limit the inflow rate to the specified value or, if at a much greater flow or frequency, it could determine that a denial of service (DoS) attack is underway. A DoS invokes a response from the apparatus 101 to drop the incoming packet and turn off the particular port 105/103 that is the recipient of the attack. This allows the apparatus 101 to perform an orderly control over the discovered DoS attack rather than allow a full system disruption. DoS attacks are used to overwhelm a system's resources such that it has little time to perform desired functions on valid traffic flows. Typically, traffic can consume up to 70% of a defined and open Ethernet data link connection rate. During a DoS attack, a hacker may send numerous packets as fast as possible where it could fill the Ethernet connection thus forcing the device to continually investigate valid, yet useless, frames while choking out valid and useful frames. Other methods can be used, but a DoS is used to garner as much of the system's resources away from valid traffic frames as possible.

The apparatus 101 provides traffic flow for both uplink and downlink directions. The following explains in detail the flow generally in an uplink direction. Since the apparatus 101 has identical flows in both directions, a brief discussion is made to the downlink direction. Referring back to FIGS. 1 and 5, in an uplink direction, downlinks 105 receive IP data streams having variable sized IP packets (step 505). The variable sized IP packets may arrive at a fixed data rate at each downlink, or at different data rates. The data rates may vary from no traffic, to data rates that are less than or greater than the configured downlink 105 or desired aggregated (uplink 103) rate.

Once the Ethernet frame has arrived at the downlink port, the frame format is checked for validity. This is performed by comparing the entire contents against the frame checksum 211. After the frame has been validated, the packets have an internal tracking header label added and are placed into packet storage 106A (step 510). The packet storage 106A is coupled to the segmentation engine 107. When ready, the segmentation engine 107 will collect a next stored Ethernet frame for processing.

The apparatus 101 examines the stored traffic from the downlink 105 and determines if it is a bandwidth control frame protocol or a data frame (step 515). If it is a bandwidth control frame, the apparatus 101 will determine the control frame instructions and adjust the apparatus 101 bandwidth accordingly (step 516). Messages can be forwarded to change the available aggregate bandwidth, which determines the bandwidth of the individual downlink(s) 105 connections. The downlink(s) 105 connections are altered accordingly so that the percentage value in relation to the aggregate total is maintained. A call administrator 113 applies the adjustments to the traffic flows (step 517). If the packet is a data frame, the apparatus 101 performs a lookup via table 129 (step 520). As discussed above, there are a variety of fields in frames 201 and 301 that can be used for initial forwarding from the packet section and on to the proper connection for proper forwarding. The chosen method will use the lookup table 129 which will be referenced when the segmentation engine 107 compares the stored packet information to previously known/learned packet information (step 520). If there is a matching value, the apparatus 101 continues to process the packet.

If the apparatus 101 had not previously resolved where to forward the packet to, it must find out where the packet must go or it will drop the packet. If the packet header information is not known, then the microprocessor 130 is asked to inquire from the applicable attached networks (step 521) and await a response. When the response returns identifying the stored packets destination path (step 522), the apparatus 101 will add the update to the lookup table 129 and process the packet. If the destination path is not identified within a predetermined time or a number of attempts, the apparatus 101 will discard the packet (step 523). The only other time a packet is dropped is when the apparatus 101 traffic path is backed up when it transmits fewer frames than it is receiving.

The segmentation engine 107 receives the labeled incoming variable sized packets and segments them to fit into smaller, and more uniform sized, 53-byte ATM cells (step 525). The segmentation engine 107 reduces and normalizes typical Ethernet frame waiting times by interleaving the segmented Ethernet frames with each other via the smaller fixed sized ATM cell format. This minimizes the wait time for any frame transmission, based upon a prioritization method, rather than waiting for the transmission completion of a previous frame. The apparatus 101 balances the priorities of each downlink(s) 105 with its transmission rate so that none of the downlink(s) 105 are cut off from transmission.

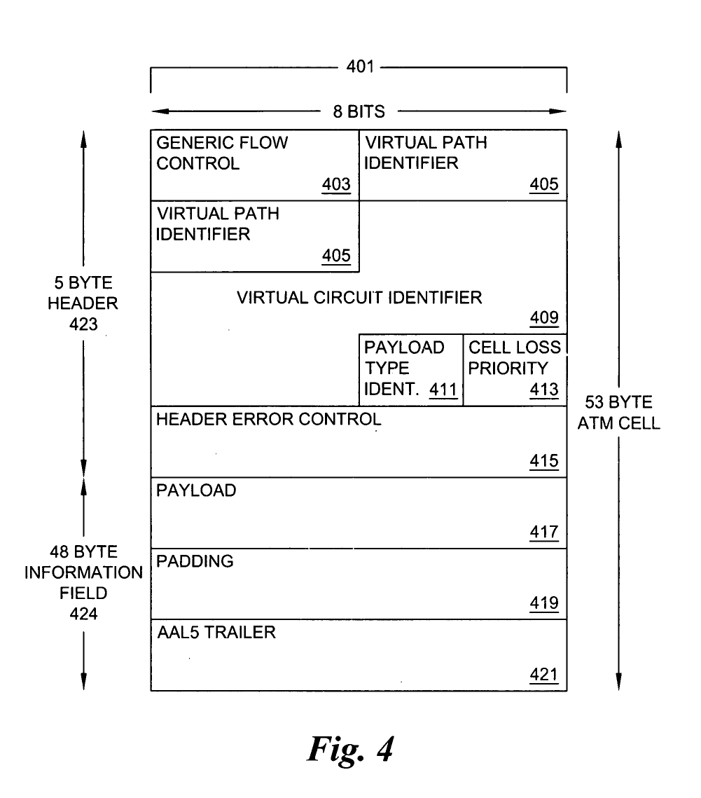

FIG. 4 shows a standard 53-byte ATM UNI cell 401. IP uses an ATM adaptation layer (AAL) to send variable-length packets up to 65,535 bytes in size across an ATM network. AAL is an ATM protocol that performs the functions of the OSI model's Data Link layer. The function of the AAL is to adapt the entering protocol to a standardized traffic handling via the ATM protocol. The AAL consists of a convergence sublayer (CS) responsible for performing functions relating to the class of service specified for the traffic being transported over ATM and a segmentation and reassembly (SAR) sublayer responsible for breaking up high-level data streams into 48-byte segments for packaging into ATM cells including any adaptation formats required. The apparatus 101 may use specification RFC1483 (bridging) and RFC1577 (discovery) before building the cells for mapping traffic through the device. If there is insufficient data to form a cell, the SAR pads the cell until filled. The AAL supports five different AAL protocols from AAL1 through AAL5 while all have specific traffic payload types.

When IP is used as the payload across an ATM network or device, it transfers an entire datagram using AAL5. Although AAL5 can accept and transfer packets that contain up to 64K bytes. Industry standards have revealed a default MTU (maximum transmission unit) of approximately 9000 bytes to provide some level of jumbo frame support. Jumbo frames are generally referred to as frames greater than 1500 bytes in length. Despite the capabilities of AAL5, IP typically restricts the size of datagrams to a value range of 64 to 1522 bytes. The maximum 1522 bytes reflect Ethernet with VLAN tagging formatting.

Unlike most network frames that place control information in the header, AAL5 places control information in an 8-byte trailer at the end of the cell. To transfer a datagram, the apparatus 101 passes through the system with the added VPI/VCI values to identify the circuit. Since both the downlink(s) 105 and uplink(s) 103 sides know AAL5 is used to prepare the frames, the apparatus 101 knows how to segment and rebuild the frames due to the common rules of AAL5. The segmentation engine 107 creates the cells from received frames using AAL5 rules by adding a trailer and dividing the frame into cells to transfer them across the apparatus 101. A reassembly engine 125 will reverse the process using the same AAL5 rules.

The AAL5 trailer 421 contains a 16-bit length field, a 32-bit cyclic redundancy check (CRC) and two 8-bit fields labeled UU and CPI that are currently unused. Each AAL5 packet is divided into an integral number of ATM cells and eventually reassembled back into a packet before delivery to either an uplink(s) 103 or downlink(s) 105. The last cell contains padding 419 to ensure that the entire packet is a multiple of 48-byte long payloads. The final cell contains up to 40 bytes of data, followed by padding bytes and the 8-byte trailer 421. AAL5 places the trailer in the last 8 bytes of the final cell where it can be found without knowing the length of the packet. The final cell is identified by a bit in the ATM header and the trailer is always in the last 8 bytes of that cell.

At a receiving end, AAL5 reassembles the cells, checks the CRC 211 to verify that no bits were lost or corrupted, extracts the datagram and passes it to an IP packet storage 106B.

The UNI cell 401 (FIG. 4) as used by the apparatus 101 is a fixed size 53-byte cell as defined by the ATM Forum specifications. It contains a cell header 423 and a 48-byte information field 424. The cell header 423 contains a generic flow control nibble field 403, a virtual path identifier (VPI) most significant nibble field 405, a VPI least significant nibble field 405, a virtual circuit identifier (VCI) most significant nibble, a VCI center byte, a VCI least significant nibble field 409, a payload type (PT) field 411, a cell loss priority (CLP) field 413 and a header error check field 415. The cell 401 may be checked upon its arrival for verifying its integrity. The first 4 bytes of the cell header are compared to the header error correction (HEC) byte 415. If successfully compared, then the cell is accepted. If not, the cell is discarded. The payload 417 is checked when reconstructed to its original form at a different layer.

The 48-byte information field 424 is used to carry the smaller pieces of a packet 201 after segmentation. Padding 419 may be added to the cell 401 that carries the last piece of the segmented packet 201. The padding is used to fill the remaining open cell space that carries the last piece of the segmented packet 201. The VPI fields 405 and the VCI fields 409 form a locally unique destination address for the cell 401.

The payload type field 411 is encoded by the segmentation engine 107 to identify the downlink/uplink cell 401 that carries the first/last piece of a segmented packet 201. The payload type field 411 can also indicate that it has encountered congestion along the traveled path. The reassembly engine 125 decides when the reassembly of a packet 201 is complete by completing the SAR function. The segmentation engine 107 may also supply a signal that indicates the cell 401 is ready for forwarding through the apparatus 101.

The 53-byte cells created by the segmentation engine 107 have their VPI/VCI fields 405 and 409 set to a value specific to a downlink(s) 105 from which the associated packet 201 was received and are transmitted to a classifier 109 towards the uplink(s). The segmentation engine 107 also encodes the payload type field 411 appropriately when a given packet 201 is converted into cells.

Based upon the port (downlink(s) 105 or uplink(s) 103) that the data Ethernet traffic entered from, the classifier 109 can examine any of the traffic from the port or the destination address field 203 and/or the EtherType 207 of a segmented packet 201 to help determine which class of service has been assigned for the associated cells 401. The result of the examination informs the classifier 109 where to forward the cells into the user's predefined class of service for that traffic flow where the class of service provides the desired prioritization. The examination is performed between the incoming data frame 201/301 and the memory 111 while including the lookup table 129 and/or memory 111. The classifier 109 may also examine the version field 303 in an IP packet 301 as a reference point. This reference point then allows the apparatus 101 to perform specific header/data inquires based upon the frame version and take appropriate forwarding actions specifically related to a specific protocol version packet style. The classifier 109 will also forward the newly assembled cell stream based upon the user's desired data rate(s), or the dynamically adjusted data rate. These flows will then feed the initial buffers of queues 119.

The classifier 109 may also examine the type of service field 307 in a segmented and encapsulated IP packet 301 and assign a predetermined class of service by referencing the type of service field 307 classification value in memory 111. Other classifications may be made when referencing other fields within a segmented and encapsulated IP packet 301. For example, a specific destination IP address 323 or range of destination IP addresses 323 may be granted a higher priority than others.

The memory 111 and lookup table 129 contain class of service identifiers for each classifiable field and is populated by a call administrator control function 113. As described above during the network design phase, a user programs the call administration 113, via a user interface tool, based on specific network requirements and on the available bandwidth of a bandwidth-limited network uplink(s) 103 if the dynamic uplink feature is not activated (steps 526, 530, 531).

Coupled to the uplink 103 may be a satellite transmitter, a terrestrial radio, or other unguided (wireless) broadband network connection that operates at its own data rate but cannot tolerate complete utilization due to atmospheric conditions. The traffic on the link may burst at the line rate but cannot sustain that rate.

Overflow entering a constrained bandwidth link is to be avoided since the attached equipment may drop traffic at random, instead of the orderly and prioritized means of dropping oversubscribed traffic, thereby affecting QoS. Also, the available bandwidth of an uplink(s) 103 (a satellite or radio link) may dynamically adjust the rate limiter 115. The satellite or radio link may send periodic messages to the apparatus 101 indicating its current bandwidth capability. The messages would be received by the segmentation engine 107, forwarded to the call administrator 113 and translated to a new available bandwidth setting for the aggregate rate limiter 115 (steps 516, 517).

This would allow the call administration control 113 to be static as in the case of a permanent or “pinned” classifications (step 530), or dynamic as in the case of a shared or temporary classification such as might be created using a resource reservation mechanism in which call setup messages are exchanged.

If the call administration control function 113 is dynamic (step 531), in response to a protocol from a constrained bandwidth link indicating the instantaneous available bandwidth of the network uplink 103 has changed, the apparatus 101 may dynamically adjust the internal virtual connections as well as the rate limiter 115. Packets are monitored for data or control bandwidth content as they enter the system.

Once the control bandwidth content packet is recognized, it is sent to a microprocessor 130 for processing. This can be accomplished by monitoring for the protocol's indications to set the aggregate bandwidth to a different value. The microprocessor 130 would adjust the internal downlink(s)/uplink(s) connections to a fixed value, or provide them with percentages of the aggregate.

For example, three connection bandwidths may be 30%, 30% and 40% of an uplink aggregate bandwidth providing 3 Mbps, 3 Mbps and 4 Mbps, respectively, of an available 10 Mbps aggregate. If the uplink aggregate bandwidth dropped to 5 Mbps, the connections would receive 1.5 Mbps, 1.5 Mbps and 2 Mbps, respectively. Even though packet traffic may be dropped, enough bandwidth would be available for a smaller portion of transmission. Providing that the entire network has been properly system engineered, the important traffic could still get through since it is better to transmit some portions of the traffic flows rather than starve or indiscriminately drop random packets. The call administration control 113 programs an aggregate rate limiter 115 and data memory 111. The rate limiter 115 provides the “logical pinch point” of the aggregate flow to reflect the expected available transmission bandwidth.

The classifier 109 places each ATM cell from a received packet into a respective service queue class 119A, 119B, 119C, . . . 119n (collectively 119) as long as the appropriate queue has enough room in it to accept all of the cells 401 associated with a packet 201 (step 535). The queues 119 each contain two paths where buffers are assigned for traffic flowing towards the rate limiter 115 while another set of associated buffers is assigned for traffic flowing from the rate limiter 115. The classifier 109 to queue 119 transfers provides the traffic's flow prioritization behavior. If a respective queue 119 signals that it does not have enough room in its buffer and drops a cell internally, then all cells 401 associated with a given packet 201 are discarded. By allowing the system to discard the now incomplete frame, internal resources are freed to ensure real and intact traffic makes its way through. The benefit is an improved overall QoS through the system, network and ultimately, applications.

The priority queues 119 services the forwarding component 121 via shapers 123A, 123B, 123C, . . . 123n (collectively 123), respectively, based off of the rate limiter 115 bandwidth setting.

The shapers 123 extract the cells from the queues 119 using a scheduling algorithm such as a form of a weighted round robin algorithm or others. The algorithm provides how the mechanism extracts cells from the queues 119 rather than how often (step 540). How often the queues are addressed is based upon the expected aggregate throughput rate. Functionally, higher priority queues 119A are serviced more often than lower priority queues 119B while queue 119n is serviced less often than the higher queues. This description assumes that there are cells present in the queues. However, another important feature of this mechanism is that when a queue is emptied, it is simply skipped by the scheduling algorithm so that the other queues can be addressed more often, continually keeping the aggregate bandwidth filled to capacity to improve overall efficiency. In contrast, the scheduling algorithm is designed so that none of the queues are completely starved from service, which would result in an unfair loss of traffic.

The forwarding component 121 provides the system with a means to move traffic to/from any downlink(s) 105 or uplink(s) 103 (step 545). The apparatus 101 architecture allows for a high-capacity throughput to provide high bandwidth capabilities while minimizing latency.

Since the apparatus 101 architecture is balanced such that the inflow of traffic is balanced with the outflow, there should be no disruption of traffic assuming the flows are within their expected limits. Passing packets or cells from one apparatus 101 component to another moves smoothly.

The shapers 123 systematically feed cells to the forwarding component 121 so that it may combine and pass traffic onto the rate limiter 115 (step 550). The effect of the queues 119, shapers 123, forwarding component 121 and rate limiter 115 is to “groom” the traffic entering the system from either a downlink(s) 105 or uplink(s) 103. The apparatus 101 initiates a smooth flow of traffic, which absorbs much of the initial “bursty” packet behavior when entering the system. The overall effect minimizes traffic jitter and latency while providing a better behaved traffic flow for other networks. This combination of system sections provides the user with a wide variety of traffic behavior patterns and choices. Downlinks 105 can be bandwidth limited and fixed or they can be configured to fill the bandwidth in the absence of other traffic. The same virtual circuits are defined in the same manner as from the uplink. It is the overall effect of definitions, queue/shaper methods and data rates that provide the overall desired and configured behavior.

Typically, network administrators routinely oversubscribe low-priority traffic so that during times of underutilized provisioned high-priority bandwidth, the low-priority traffic may be allowed to use the otherwise unused bandwidth, thus providing for statistical multiplexing gain. In addition to the specific prioritization connection limits, the aggregate rate limiter 115 prevents overall oversubscribed traffic from reaching the bandwidth constrained network uplink 103.

By providing a means to logically restrict the overall throughput bandwidth, the user would have control of a previously uncontrolled data link interface. Ethernet is an open interface standard. It is fixed at 10 Mbps, 100 Mbps, etc. Combined downlinks and uplinks are controllable via the internal connections and especially by the rate limiter 115.

When the rate limiter 115 is configured to pass a specific amount of traffic, it extracts cells from the forwarding component 121 at this specified rate. Clocks (not shown) controlling the rate limiter 115 are either entered by the user for a fixed determined amount of bandwidth or can be controlled via a dynamic protocol which can dynamically set the bandwidth rate. The rate limiter 115 accepts and forwards the cells at the specified rates while minimizing latency throughput times through the use of small amount of buffers, typically 3 to 16 cells per connection flow.

The small, uniform cells created by the segmentation engine 107 provide the opportunity for higher-priority traffic to pass, interleaved with lower-priority traffic minimizing total throughput latency. The apparatus 101 minimizes the wait time between packet transmissions. Therefore, if a larger low-priority packet is traversing the system and a higher-priority packet enters, the higher-priority packet has a chance to advance due to the prioritization, queuing, and shaping mechanisms to attain this traffic grooming effect. The aggregate rate limiter 115 prevents traffic at a (defined data) rate from entering a bandwidth limited network uplink operating at a slower rate. If the rate limiter 115 is set to pass 10 Mbps of traffic, then all or any of the user traffic streams will not be allowed to pass more than 10 Mbps of traffic even though it may be connected to a 100 Mbps data link Ethernet interface (step 550). The apparatus 101 provides this functionality in both uplink and downlink directions (full duplex) simultaneously. The benefit is that networks on the application side of the apparatus 101 are protected from excessive traffic affecting QoS as the aggregate network is protected from excessive user transmissions. Excessive traffic on either side is thereby limited.

Another means to control configured bandwidth availability is by the use of a backpressure mechanism. The backpressure mechanism (step 550) pushes back on the forwarding path so that the apparatus 101 can tell the originating end it has entered into a congested state. Whether in a non-congested or congested state, an embodiment may drop all associated cells of a particular frame if one cell in the group is discarded. Therefore, if one piece of the frame is lost, the apparatus 101 resources are cleared of all remaining remnants of the frame rather than forward an incomplete frame that wastes bandwidth.

The cells 401 passed by the aggregate rate limiter 115 are passed through the forwarding component 121, into the queues 119 pointing towards the uplink direction and to the declassifier 120 (step 555). The declassifier 120 accepts the traffic flow from the queues while referencing the VPI/VCI fields and sends them to the reassembly engine 125 for reconstructing the Ethernet/IP packets from the cell flow (step 560). The reassembly engine 125 determines that a reassembly is complete when appropriate payload type field encoding detects the last cell associated with a given packet 201.

Reassembled packets 201 are forwarded to packet storage 106B (step 565) to await transmission to a destination uplink 103 (step 570). These packets are placed into the section of packet storage based upon the associated VPI/VCI flow location. This ties the VPI/VCI cell flow path to a predetermined portion of packet storage. This maintains the security aspect of separating various interface ports from each other unless a user associates multiple ports with each other.

In addition to storing the packets, the lookup table 129 is updated such that applicable tracking fields are noted for future system or user reference. This may provide the indication for a particular traffic flow and its association to a particular uplink or downlink.

If more than one uplink 103 is used, it is possible that particular downlinks traffic flows may be associated to a primary uplink. Secondary and tertiary links may be assigned as well while assuring that the downlink traffic flow is prioritized over other traffic flows in a totalitarian fashion. The packets of a particular flow may not be distributed across multiple links due to the unknown characteristics of the various links since it is probable that these links may contain characteristics such as varying latency and reliability issues.

For example, uplink 1 103A can be a terrestrial link having a 20 ms delay and uplink 2 103B can be a satellite link having a 500 ms delay in the same direction. Reassembling the individual packet flows at a destination address in their proper order would be difficult to recreate accurately.

The foregoing description teaches traffic flow generically in an uplink direction. The apparatus 101 also controls traffic flow in a downlink direction. The method (FIG. 6) is similar to the uplink direction except that the packet flow starts from an uplink(s) 103 (step 605) and is applied to the packet storage 106A after it is validated and labeled (step 610). The apparatus 101 uses a separated section of the packet storage 106A memory for security and traffic separation. The flow of traffic is identical to the uplink direction flow, but in the opposite, or full duplex direction.

A received packet is examined to determine if it is a bandwidth control packet or a data packet (step 615). If it is a bandwidth control packet, it is processed by the microprocessor 130 (step 616) for applying to the call administrator 113 so that aggregate and/or virtual circuit changes can be made (step 617).

If the packet is a data packet, the apparatus 101 checks for a known identifier (step 620) as explained above so that the apparatus 101 can forward the packet to the right location. If the apparatus 101 does not recognize the packet, the microprocessor 130 discovers the packet destination (step 621). After a response returns (step 622), the lookup table is updated and the packet is forwarded for segmentation processing 107 (step 625). If the identifying information is not discovered after waiting a set time or attempting a number of tries, the packet can be dropped (step 623). As described above during the network design phase, a user programs the call administration 113, via a user interface tool, based on specific network requirements and on the available bandwidth of a bandwidth-limited network uplink(s) 103 if the dynamic uplink feature is not activated (steps 626, 630, 631).

The cell traffic flow is then forwarded to their individual rate limited direction buffer queues 119 (step 635). These streams are then moved toward the forwarding component 121 at their assigned data rates not to exceed the overall aggregate rate (step 640) via the shapers 123. Multiple stream flows are combined and moved to the rate limiter 115 (step 645). The effect of the queues 119, shapers 123, forwarding component 121 and rate limiter 115 “grooms” the traffic.

The backpressure mechanism (step 650) pushes back on the forwarding path so that the apparatus 101 can instruct the originating end it has entered into a congested state.

The final steps are to move the groomed traffic towards the associated downlinks 105 by passing the traffic through the downlink 105 direction queues (step 655), reassemble 125 the cells into individual packets (step 660), store the packets in packet storage 106B (step 665) and forward them to the particular downlink(s) 105 (step 670).

Various changes may be made to the structure embodying the principles of the invention. The foregoing embodiments are set forth in an illustrative and not in a limiting sense. The scope of the invention is defined by the claims appended hereto.

What is claimed is:

1. A method of providing quality of service for IP networks when transmitting IP data streams over a constrained bandwidth data link comprising:
receiving a plurality of downlink IP data streams containing packets and at least one uplink IP data stream containing packets;
assigning each downlink packet and each uplink packet a priority and a data rate;
segmenting each downlink packet and each uplink packet into a number of cells corresponding to their packet;
selecting downlink cells based on their assigned packet priority and at their assigned packet data rate;
selecting uplink cells based on their assigned packet priority and at their assigned packet data rate;
assembling the selected downlink and uplink cells back to their original packets;
addressing the downlink packets to a destination uplink; and
addressing the uplink packets to a destination downlink.

2. The method according to claim 1 further comprising determining each assigned downlink packet priority from a downlink that it is received from.

3. The method according to claim 1 further comprising determining each assigned downlink packet priority and each uplink packet priority from any portion of the downlink or uplink packet's Ethernet frame or TCP/IP fields.

4. The method according to claim 1 wherein the sum of all downlink packet data rates for packets having the same destination uplink is less than or equal to a data rate of the destination uplink (uplink aggregate data rate).

5. The method according to claim 1 wherein the sum of all uplink packet data rates for packets having the same destination downlink is less than or equal to a data rate of the destination downlink (downlink aggregate data rate).

6. The method according to claim 1 further comprising:
detecting a denial of service (DoS) attack on a downlink IP data stream and/or an uplink IP data stream; and
blocking the downlink IP data stream and/or uplink IP data stream experiencing the DoS attack.

7. The method according to claim 1 wherein the downlink packet data rates for packets having the same destination uplink are equal to or greater than a data rate of the destination uplink (uplink aggregate data rate).

8. The method according to claim 1 wherein the uplink packet data rates for packets having the same destination downlink are equal to or greater than a data rate of the destination downlink (downlink aggregate data rate).

9. The method according to claim 1 further comprising assigning a data rate percent for each downlink packet data rate.

10. The method according to claim 9 wherein the sum of all downlink packet data rate percents for downlink packets having the same destination uplink cannot exceed 100 percent.

11. The method according to claim 10 further comprising:
receiving an uplink aggregate data rate instruction contained in an uplink IP data stream; and
setting the data rate of a destination uplink (uplink aggregate data rate) according to the instruction.

12. The method according to claim 11 further comprising limiting each downlink packet's data rate having the same destination uplink according to their data rate percent of their destination uplink data rate.

13. The method according to claim 12 wherein if a downlink packet's data rate is greater than its data rate percent of the destination uplink data rate, packets associated with that downlink are dropped to meet its data rate percent of the destination uplink data rate.

14. The method according to claim 10 further comprising dynamically adjusting each downlink packet's data rate percent if one or more downlink IP data streams having the same destination uplink do not have packets.

15. The method according to claim 1 further comprising assigning a data rate percent for each uplink packet data rate.

16. The method according to claim 15 wherein the sum of all uplink packet data rate percents for uplink packets having the same destination downlink cannot exceed 100 percent.

17. The method according to claim 16 further comprising:
receiving a downlink aggregate data rate instruction contained in a downlink IP data stream; and
setting the data rate of a destination downlink (downlink aggregate data rate) according to the instruction.

18. The method according to claim 17 further comprising limiting each uplink packet's data rate having the same destination downlink according to their data rate percent of their destination downlink data rate.

19. The method according to claim 18 wherein if an uplink packet's data rate is greater than its data rate percent of the destination downlink data rate, packets associated with that uplink are dropped to meet its data rate percent of the destination downlink data rate.

20. The method according to claim 16 further comprising dynamically adjusting each uplink packet's data rate percent if one or more uplink IP data streams having the same destination downlink do not have packets.

21. An apparatus for providing quality of service for IP networks when transmitting IP data streams over a constrained bandwidth data link comprising:
means for receiving a plurality of downlink IP data streams containing packets and at least one uplink IP data stream containing packets;
means for assigning each downlink packet and each uplink packet a priority and a data rate;
means for segmenting each downlink packet and each uplink packet into a number of cells corresponding to their packet;
means for selecting downlink cells based on their assigned packet priority and at their assigned packet data rate;
means for selecting uplink cells based on their assigned packet priority and at their assigned packet data rate;
means for assembling the selected downlink and uplink cells back to their original packets;
means for addressing the downlink packets to a destination uplink; and
means for addressing the uplink packets to a destination downlink.

22. The apparatus according to claim 21 further comprising means for determining each assigned downlink packet priority from a downlink that it is received from.

23. The apparatus according to claim 21 further comprising means for determining each assigned downlink packet priority and each assigned uplink packet priority from any portion of the downlink or uplink packet's Ethernet frame or TCP/IP fields.

24. The apparatus according to claim 21 wherein the sum of all downlink packet data rates for packets having the same destination uplink is less than or equal to a data rate of the destination uplink (uplink aggregate data rate).

25. The apparatus according to claim 21 wherein the sum of all uplink packet data rates for packets having the same destination downlink is less than or equal to a data rate of the destination downlink (downlink aggregate data rate).

26. The apparatus according to claim 21 further comprising:
means for detecting a denial of service (DoS) attack on a downlink IP data stream and/or an uplink IP data stream; and
means for blocking the downlink IP data stream and/or uplink IP data stream experiencing the DoS attack.

27. The apparatus according to claim 21 wherein the downlink packet data rates for packets having the same destination uplink are equal to or greater than a data rate of the destination uplink (uplink aggregate data rate).

28. The apparatus according to claim 21 wherein the uplink packet data rates for packets having the same destination downlink are equal to or greater than a data rate of the destination downlink (downlink aggregate data rate).

29. The apparatus according to claim 21 further comprising means for assigning a data rate percent for each downlink packet data rate.

30. The apparatus according to claim 29 wherein the sum of all downlink packet data rate percents for downlink packets having the same destination uplink cannot exceed 100 percent.

31. The apparatus according to claim 30 further comprising:
means for receiving an uplink aggregate data rate instruction contained in an uplink IP data stream; and
means for setting the data rate of a destination uplink (uplink aggregate data rate) according to the instruction.

32. The apparatus according to claim 31 further comprising means for limiting each downlink packet's data rate having the same destination uplink according to their data rate percent of their destination uplink data rate.

33. The apparatus according to claim 32 wherein if a downlink packet's data rate is greater than its data rate percent of the destination uplink data rate, packets associated with that downlink are dropped to meet its data rate percent of the destination uplink data rate.

34. The apparatus according to claim 30 further comprising means for dynamically adjusting each downlink packet's data rate percent if one or more downlink IP data streams having the same destination uplink do not have packets.

35. The apparatus according to claim 21 further comprising means for assigning a data rate percent for each uplink packet data rate.

36. The apparatus according to claim 35 wherein the sum of all uplink packet data rate percents for uplink packets having the same destination downlink cannot exceed 100 percent.

37. The apparatus according to claim 36 further comprising:
means for receiving a downlink aggregate data rate instruction contained in a downlink IP data stream; and
means for setting the data rate of a destination downlink (downlink aggregate data rate) according to the instruction.

38. The apparatus according to claim 37 further comprising means for limiting each uplink packet's data rate having the same destination downlink according to their data rate percent of their destination downlink data rate.

39. The apparatus according to claim 38 wherein if an uplink packet's data rate is greater than its data rate percent of the destination downlink data rate, packets associated with that uplink are dropped to meet its data rate percent of the destination downlink data rate.

40. The apparatus according to claim 36 further comprising means for dynamically adjusting each uplink packet's data rate percent if one or more uplink IP data streams having the same destination downlink do not have packets.

41. An apparatus for providing quality of service for IP networks when transmitting IP data streams over a constrained bandwidth data link comprising:
a plurality of downlink ports configured to receive and output an IP data stream containing packets;
at least one uplink port configured to receive and output an IP data stream containing packets;
a segmentation engine coupled to the downlink ports and the at least one uplink port, the segmentation engine configured to segment received downlink and uplink packets into downlink and uplink cells corresponding to their packet;
a classifier coupled to the segmentation engine, the classifier configured to prioritize the downlink and uplink cells according to a packet priority;
a plurality of traffic queues coupled to the classifier, each traffic queue configured to store downlink and uplink cells according to their packet priority;
a plurality of shapers, one coupled to each traffic queue, each shaper configured to extract the downlink and uplink cells from the traffic queues using a scheduling algorithm;
a forwarding component coupled to the plurality of shapers, the forwarding component configured to select and combine cells from the shapers;
a rate limiter coupled to the forwarding component, the rate limiter configured to select downlink cells from the forwarding component based on an assigned downlink packet data rate and an aggregate data rate of a destination uplink and select uplink cells from the forwarding component based on an assigned uplink packet data rate and an aggregate data rate of a destination downlink; and
a reassembly engine coupled to the rate limiter, the reassembly engine configured to reassemble downlink and uplink cells from the forwarding component back to their original packet for output at their destination uplink or destination downlink port.

42. The apparatus according to claim 41 wherein the priority for a received downlink packet corresponds with a priority assigned to the downlink port where it is received from.

43. The apparatus according to claim 41 wherein the priority for a received downlink packet and a received uplink packet is found in any portion of the downlink or uplink packet's Ethernet frame or TCP/IP fields.

44. The apparatus according to claim 41 wherein the sum of all downlink packet data rates for packets having the same destination uplink is less than or equal to the data rate of the destination uplink (uplink aggregate data rate).

45. The apparatus according to claim 41 wherein the sum of all uplink packet data rates for packets having the same destination downlink is less than or equal to the data rate of the destination downlink (downlink aggregate data rate).

46. The apparatus according to claim 41 wherein the segmentation engine is further configured to detect a denial of service (DoS) attack on a downlink IP data stream and/or an uplink IP data stream and block the downlink IP data stream and/or uplink IP data stream experiencing the DoS attack.

47. The apparatus according to claim 41 wherein the downlink packet data rates for packets having the same destination uplink are equal to or greater than a data rate of the destination uplink (uplink aggregate data rate).

48. The apparatus according to claim 41 wherein the uplink packet data rates for packets having the same destination downlink are equal to or greater than a data rate of the destination downlink (downlink aggregate data rate).

49. The apparatus according to claim 41 further comprising a call administrator configured to receive a data rate instruction contained in an uplink and/or downlink data stream to set the data rate of that uplink and/or downlink according to the instruction.

50. An IP quality of service apparatus comprising:
a housing having:
a plurality of downlink ports configured to receive and output an IP data stream containing packets;
at least one uplink port configured to receive and output an IP data stream containing packets;
a segmentation engine coupled to the downlink and uplink ports configured to segment downlink and uplink packets into downlink and uplink cells corresponding to their packet;
a classifier coupled to the segmentation engine, the classifier configured to prioritize the downlink and uplink cells according to their packet priority;
a plurality of traffic queues coupled to the classifier, each traffic queue corresponding to a downlink and uplink packet priority;
a plurality of shapers, one coupled to each traffic queue, each shaper configured to extract the downlink and uplink cells from the traffic queues using a scheduling algorithm;
a forwarding component coupled to the plurality of shapers, the forwarding component configured to select and combine cells from the shapers;
a rate limiter coupled to the forwarding component, the rate limiter configured to select downlink cells from a shaper based on an aggregate data rate of a destination uplink and to select uplink cells at an aggregate data rate of a destination downlink; and
a reassembly engine coupled to the rate limiter, the reassembly engine configured to reassemble downlink and uplink cells from the rate limiter back to their original downlink and uplink packets for output at their destination uplink or destination downlink port.
